(19) United States
(12) Patent Application Publication
(10) Pub. No.: US 2023/0050160 A1
(43) Pub. Date: Feb. 16, 2023

(54) A SYSTEM AND A METHOD FOR PERFORMING ATOMIC SWAP TRANSACTIONS OF DIGITIAL RECORDS AMONG A PLURALITY OF DITRIBUTED DATABASES

(71) Applicant: QPQ LIMITED, Dublin (IE)

(72) Inventors: Greg Chew, Dublin (IE); Ryan Leckey, Roseville, CA (US); Emanuele Ragnoli, Dublin (IE); Gokhan Sagirlar, Dublin (IE)

(21) Appl. No.: 17/796,810

(22) PCT Filed: Feb. 4, 2020
(86) PCT No.: PCT/EP2020/052768

§ 371 Date: Aug. 1, 2022

(51) Int. Cl. G06F 9/46; G06F 16/23; H04L 9/32; H04L 9/00

(52) U.S. Cl. CPC G06F 9/466; G06F 16/2358; H04L 9/3236; H04L 9/50

(57) ABSTRACT

The present invention relates to a system and a method for performing exchanges of digital data records among a plurality of distributed databases. More specifically, the present invention relates to a technology agnostic atomic swap system platform configured to perform atomic swap transactions of digital data records among a plurality of distributed ledger technology platforms.

### FIELD

The present invention relates to a system and a method for performing exchanges of digital data records among a plurality of distributed databases. More specifically, the present invention relates to a technology agnostic atomic swap system platform configured to perform atomic swap transactions of digital data records among a plurality of distributed ledger technology platforms.

### BACKGROUND

Distributed ledger technology (DLT) platforms based on blockchain technology are widely known for their use in decentralised networks for the implementation of cryptocurrency applications. However, the fundamental blockchain technology and the use of DLT platform can be used in a range of new system applications that go beyond the cryptocurrency domain, such as to secure transaction between different systems in a centralised and/or decentralised distributed network, which may involve an atomic swap of digital records among a plurality of DLT platforms.

Atomic swap is a well-known concept in the cryptocurrency community, and involves the swap or exchange of digital assets, such as cryptocurrencies, between parties. For the swap transaction to be considered as “atomic” it requires that it is executed either at all nodes of the distributed network or at none, and that the result is the same for all of them. In an atomic swap system, the execution of an atomic swap of digital assets involves the use of a hash time-locked smart contract, which necessitate that the parties involved deliver the digital asset to be swapped within a specified time, or else the transaction will be cancelled.

In an atomic swap, each DLT platform may process the atomic swap transaction and independently obtain a local and/or global consensus on the validity of the transaction. A global consensus system may be used to obtain a consensus on the validity of the transaction. To obtain a consensus from the global consensus system requires that each DLT platform transmits its current local state or local state changes occurred from processing a submitted transaction.

However, there are certain disadvantages with current solutions for performing atomic swap transactions that limit their widespread adoption. These disadvantages mainly relate to the long delays experienced when executing atomic swap transactions, and compatibility issues when integrating heterogeneous DLT platform configurations to a global consensus platform for transaction ordering and timestamping.

### SUMMARY OF THE INVENTION

It is an object of the present invention to provide an atomic swap system and a method for performing atomic swap transactions that overcome the disadvantages of existing solutions.

It is another object of the invention to provide a distributed ledger (DLT) communication module configured to connect DLT platforms of different technologies to a global consensus module for consensus ordering and timestamping.

According to a first aspect of the present invention, a distributed ledger, DLT, communication module is provided, which is configured for connecting a distributed ledger technology, DLT, platform with a global consensus module for consensus ordering and timestamping, wherein the DLT communication module comprising:

a state adopter module configured to retrieve and push to the global consensus module transactions submitted to the DLT platform, the transactions at least referencing local states and/or local state changes of the DLT platform; and a status provider module configured to maintain and track the transactions processed by the global consensus module;
wherein the state adopter module is configured to search in the status provider module for processed transactions containing any of the local states and/or local state changes referenced in the submitted transactions, and upon finding matching transactions notifying the at least one DLT platform of the valid processing of the submitted transactions by the global consensus module.

The present invention provides a DLT communication module for connecting DLT platforms of different technologies to a global consensus module, which enables for local DLT states or local state changes to be transferred from private DLT platform and the global consensus module. The DLT communication module is configured to create a communication link between the private DLT platform and the global consensus module to enable the transfer of local DLT states and/or local DLT state changes. The DLT communication module is configured, by mean of the state adopter module to retrieve and push transactions submitted to the DLT platform. Depending on the configuration of the DLT platform, the transactions retrieved by the state adopter module may contain, the details of the atomic swap transaction, and/or the local states of the DLT platform, and/or the local state changes of the DLT. The DLT communication module may be operated in at least two modes:
a) Local consensus is delegated to the global consensus module: If a DLT platform connected to the DLT communication logic delegates the process for reaching a local consensus for the validity of a transaction to the global consensus module, then the DLT communication module is configured, by means of the state adopter module, to fetch and submit to the global consensus module every transaction submitted by a client to the DLT platform. The DLT communication module is configured to monitor the transactions processed by the global consensus module and accordingly notify the DLT platform of whether the transaction was validly processed or rejected by the global consensus module. If the transaction was validly processed, then the DLT communication module returns the consensus order and timestamp of the transaction to the corresponding DLT platform. If the transaction is rejected, then it notifies the DLT platform that the transaction is not valid and should be rejected.
b) Local consensus is reached locally in the DLT and state changes are registered with a global consensus module: If the DLT platform connected to the DLT communication module reaches consensus locally, e.g. using a set of transaction checker nodes (TCs) having its own consensus protocol, then DLT communication module fetches local state changes from asset of local TCs that have been pre-selected by the global consensus module, and submits the local DLT state changes registered by the selected set of TCs to the global consensus module for processing. Upon completion of the submitted states' processing in the global consensus module, the state adopter returns the consensus order and the timestamp of the processed states to the local TC set of the corresponding DLT.
   The DLT communication module is configured to transmit information only relating to each of the connected DLT platforms while preventing the transmission of information relating to other DLT platforms using the global consensus module for consensus ordering and timestamping. The DLT communication module comprises a Status Provider (SP) module, which is connected to the state adopter module and the global consensus module. The status provider main task is to track and monitor the latest status of state changes occurring in the global consensus module and pushing those changes to the status adopter for communication to the corresponding DLT platforms. Generally, the global consensus module provides a global ordering and timestamping of the submitted transaction but does not necessarily store historical information relating to processed transactions, which could be used to report on a validly processed transaction and/or previous attempts for spending the DLT local states referenced by an atomic swap transaction. The status provider enables the transactions checker nodes of each DLT platform to:
gather global consensus order and timestamp for the submitted transactions to the DLT platform,
provide confirmation that a local DLT state change, which may occur after the local processing of an atomic swap transaction or another type of transaction, has been processed globally by the global consensus module.
   The DLT communication module of the present invention, has the advantage of connecting different types of permissioned/private DLT platforms, which might either have a local consensus mechanism or not, to a global consensus provider. In this way, it is easier for users of different DLT platforms to perform atomic swaps via a centralised global consensus module. Furthermore, the DLT communication module ensures that only information relating to the corresponding connected DLT platform is transferred to and from the global consensus module. According to embodiments of the present invention each

According to embodiments of the present invention, the state adopter module comprises a local state communication module configured to retrieve transactions submitted to the DLT platform. The local communication module comprising a communication protocol library comprising a plurality of communication protocols, each associated with a DLT platform configuration. According to embodiments of the present invention, the local communication module is configured to identify the communication configuration of the connected DLT platform and accordingly select a compatible communication protocol from the communication protocol library to enable the exchange of information. The local communication module is configured to convert the format of information exchanged between the connected DLT platform and the global consensus module.

The DLT communication module of the present invention is provided with a communication protocol library, which contains communication configuration information for different DLT platforms. The communication module is configured to detect, or receive, information on the configuration of the DLT platformed to be connected to the global consensus module and accordingly select from the protocol library the corresponding communication protocol to establish the communication interface between the private DLT platform and the global consensus module. For example, before each new DLT platform is integrated to the system, first, it has to present itself and its intention to join the ecosystem e.g. the atomic swap ecosystem to perform atomic swap transactions. Furthermore, each DLT needs to provide details of at least one of: its transaction checker (TC) nodes set, current state of the ledger, and its assets to the Global consensus module, which check the validity of the TC set and current state of the ledger. Each DLT chooses whether the local consensus is delegated to the Global consensus module or it is reached locally in the DLT, and accordingly the Global consensus module determine whether to integrate the TC set of each DLT to the ecosystem. Communication protocol specification procedure is executed between DLT and the communication module. This procedure consists steps including but not limited to deciding which internet transmission protocol to use (e.g. TCP, UDP, multicast, unicast etc.), setting up the Public Key Infrastructure, setting up the encryption/decryption mechanism, and, setting up a common encoding/decoding scheme. Therefore, with the provision of the DLT communication module of the present invention, it is possible to perform atomic swaps of assets among heterogenous DLT platforms that reach global consensus and ordering of transactions.

According to embodiments of the present invention, the state adopter module comprises a DLT state checking module configured to search in the status provider module for historical transactions consuming any of the DLT local states associated with the submitted transaction, and to compare the unique consensus orders and timestamps of any historical transaction identified as consuming any of the DLT local states to detect previous attempts for consuming the DLT local states associated with the submitted transaction. According to embodiments of the present invention the DLT state checking module is configured for retrieving information on consumed DLT local states from a local DLT consensus module. According to embodiments of the present invention, the DLT state checking module is configured upon detecting that the local states associated with the submitted transaction have been consumed by a previous transaction, the state adopter module is configured to notify the distributed ledger platform to reject the submitted transaction, otherwise the state adopter module is configured to notify the DLT platform to validate the submitted transaction.

In the case, where the connected private DLT platform delegates the consensus to a global consensus module, the current DLT local state of the DLT needs to be transferred to the global consensus module together with the information on the submitted atomic swap transaction. The DLT communication module, in order to prevent double-spending of the DLT states referenced by the atomic swap transaction, checks by means of the DLT state checker in the status provider module for consensus order and timestamps of historic transactions processed by the global consensus module that include the states references by the submitted atomic swap transaction, and accordingly notify the corresponding DLT platform to either accept or refuse the atomic swap transaction. In this way, it may be possible to prevent attempts to double-spend the states of a connected DLT platform, leading to fraudulent behaviour. Therefore, with the DLT communication module of the present invention, it is possible to detect invalid transactions, which may have otherwise been validly processed by the DLT platform.

According to embodiments of the present invention, the status provider module is a mirroring computing node configured to push global DLT state changes of the global consensus module to the state adopter module.

The status provider may be a computing node, such as a mirroring node, that tracks the transactions processed by the global consensus modules. The status provider may further be configured to store the processed transactions, thus generating a searchable archive. The status provider may be in the form of a computing node that duplicates the operation of the global consensus module, thereby providing access to the processed transactions.

According to a second aspect of the present invention, an atomic swap engine may be provided for orchestrating the exchange of digital records involved in an atomic swap transaction between at least one initiator party and at least one collaborator party, the digital records involved in the atomic swap transaction being stored in corresponding DLT platforms associated with the at least one initiator party and at least one collaborator party, the atomic swap system comprising:

a connector module configured to process and execute atomic swap transaction requests received from at least one initiator party via a client application involving the exchange of digital records stored in at least one initiator party DLT platform and digital records stored in at least one collaborator party DLT platform;
a global consensus module configured to validate, record and track state changes of the connected DLT platforms participating in the atomic swap transactions;
a plurality of DLT communication module according to the first aspect of the present invention, each communicatively coupling a DLT platform to the global consensus module;
wherein upon receiving via a client application software a notification from the at least one collaborating party that the atomic swap transaction is accepted, the connector module is configured to:
locate and validate the digital records referenced in the atomic swap request in the corresponding initiator party DLT platform and collaborator party DLT platform,
execute the atomic swap transaction by assigning the digital records in the initiator DLT platform to the at least one collaborating party and the digital records in the collaborating DLT platform to the at last one initiator party, and locking the exchanged digital records in the corresponding initiator and collaborator DLT platforms,
request the at least one initiator party DLT platform to push, via the corresponding DLT communication module, the DLT local state change introduced by the execution of the atomic swap transaction to the global consensus module; and
upon receiving a confirmation from the corresponding DLT communication module that the atomic swap transaction is validly processed by the global consensus module, to transfer to the at least one initiator party and at least one collaborator party a key to release the exchanged digital records in the corresponding DLT platforms.

The atomic swap engine (ASE) disclosed by the present invention, offers at least the following advantages:
ASE performs atomic swap transactions across several distributed ledger platforms through the Global consensus module that provides global consensus and ordering of transactions. Particularly, the global consensus module projects local state changes in distributed ledger platforms to global state changes in global consensus module. For example, the local state changes of a DLT platform are reflected in a global distributed ledger maintained by the global consensus module. As such, the global state of the global consensus module maintains references to all local states of the connected distributed ledgers, and accordingly the global consensus module is updated with the submission of new local states. In this way, transactions can be validated by the global consensus module while considering previous state changes made to each of the connected DLT, thereby preventing malicious attempts to double-spend previously consumed DLT states.
ASE is able to perform atomic swap transactions among several distributed ledger platforms and parties. For example, it can perform atomic swap transactions having inputs from three parties that are part of three different ledger platforms, and outputs to three different parties in three different ledgers, presented as 3-to-3 atomic swaps. This is achieved by locking the digital records referenced in the atomic swap so that access is granted only when the swap has been executed successfully.
Existing private/permissioned distributed ledger platforms (e.g. Corda, Hyperledger Fabric etc.) can delegate their consensus tasks to ASE through the Global consensus module. I.e. they can use the global consensus module of ASE as a consensus provider for not only atomic swap transactions, but also for their local transactions without leaking any confidential information.
ASE is platform agnostic, such that any private/permissioned distributed ledger platform that integrates to ASE (which requires the submission of its local state to the global consensus module) may perform atomic swaps with other platforms.

According to embodiments of the present invention, the atomic swap engine comprises a cryptographic module configured to anonymise the retrieved transactions. For example, the cryptographic module is configured to anonymize the retrieved transaction by removing and/or obfuscating sensitive information attributed to a specific data subject. Furthermore, the cryptographic module may be configured to hash and/or encrypt the retrieved transactions.

The cryptographic module may perform a number of different operations to ensure that any sensitive information exchanged between each private DLT platform and the global consensus module is cryptographically secured. The cryptographic module may perform the operations of:

Data Obfuscation for masking private data with modified new content.

Data Encryption for the conversion of private input data to encoded format such that only authorized parties can access to the private data.

Data Pseudonymization and Anonymization refers to set of operation performed on input data to ensure that processed private data may no longer be attributed to particular data subject.

Data hashing: the application of hash functions to data, e.g. a cryptographic hash function, which is a cryptographic one-way function, to map arbitrary size input to fixed-size output hash. An important property of cryptographic hash functions is they are practically infeasible to invert, i.e. calculate/find input of a hash function from its output hash.

The cryptographic module may be used in the process of locking the digital records during an atomic swap transaction, using a set of cryptographic hash functions to prevent the owner of a digital record in an atomic swap transaction to unlock the digital assets before a set of specified conditions are met. For example, in Hashed Time Lock Contract (HTLC), which is type of smart contract on DLTs that is used to perform atomic swaps, the digital assets to be swapped may be locked to users with time-bounds using hash locks and time locks, by exploiting cryptographic techniques such as cryptographic hash functions and cryptographic signatures.

According to embodiments of the present invention, wherein the connector module is configured to lock the exchanged digital records using a state hash value key generated by means of the cryptographic module from a hash function obtained from a state change of the at least one initiator DLT platform. The cryptographic module is configured to generate separate state hash value keys for the at least one initiator party and at least one collaborator party to inlock the respective swapped digital records. For example, the initiator party key may be generated based on the state hash value and a reference to the state changes of the global consensus module distributed ledger platform.

According to embodiments of the present invention, wherein the connector module is communicatively coupled to an escrow module configured to lock the digital records involved in the atomic swap transaction. The escrow module comprising a smart contract programme operating on each connected DLT platform, which is configured to lock the digital records with time-bounds using hash locks and time locks generated from cryptographic hash functions and cryptographic signatures. For example, the escrow module is configured to release the locked digital records upon certain conditions of the atomic swap execution are satisfied. The escrow module may be part of the DLT platform or installed when the DLT platform is integrated to the Atomic Swap Engine (ASE).

The connector module enables the locking of the digital records to be swapped to the corresponding party. By locking the digital records, several swap transactions may occur simultaneously, or at least substantially simultaneously, between multiple parties. Digital record locking may be performed by an escrow module, which may be configured to execute in each of the DLT platforms participating in the swap a smart contract, which locks the digital records referenced in the atomic swap transaction. The smart contract may lock the digital records with time-bounds using hash locks and time locks generated from cryptographic hash functions and cryptographic signatures e.g. from the cryptographic module. The smart contract performing the locking function may be downloaded and installed in the corresponding DLT platform by each party wishing to initiate or participate in an atomic swap transaction. The smart contract may be removed from the DLT platform once the atomic swap transaction has been completed or maintained for future use. The smart contract may be a Hashed Time Lock Contract (HTLC). A HTLC locks assets to users with time-bounds using hash locks and time locks, by exploiting cryptographic techniques such as cryptographic hash functions and cryptographic signatures.

According to embodiments of the present invention, the global consensus module comprises a global committee selection module configured for selecting Transaction Checker (TC) nodes from connected DLT platform to form a set of global transaction consensus nodes participating in the validation, recording and tracking of state changes of the connected DLT platforms participating in the atomic swap transactions.

The global committee module selects transaction checker (TC) nodes from all connected DLT platform to form the global transaction consensus nodes that would participate in the global consensus for ordering and timestamping transactions. The global committee module may perform at least the following function:
check the functionality of the local committee members—The global committee module may periodically poll the selected TC nodes to ensure that they are still operational and can reach a defined and valid state in a finite and/or agreed bounded time.
measure metrics like safety and liveness. In a consensus protocols, the safety property requires that, during the consensus ordering execution, malicious or unexpected transactions are prevented from being processed and validated by the consensus module. The liveliness property requires the consensus committee members to reach a defined and valid state in a finite or agreed bounded time.
implement and records rewards schemes—for example local consensus committee members may be rewarded if they exhibit, e.g. consistently, a fair and honest behaviour in validating transactions. On the other hand, the consensus committee members may be penalised if they exhibit a malicious or suspicious behaviour e.g. a selected TC node tries to validate a suspected/fraudulent transaction that would compromise the safety metric of the consensus protocol.

The global consensus module is configured to validate a transaction using the TC nodes selected by the global selection committee modules, which selected TC nodes form a distributed global consensus protocol. As a result, TC nodes with a malicious behaviour, would not affect the behaviour of the remaining TC nodes in the global consensus protocol. In this way, the global consensus module may act as a trusted body for validating local transactions in private DLT platforms.

According to embodiments of the present invention, the global committee module may select TC nodes based on a number of parameters that are defined according to and satisfy various fault tolerance (e.g. crash fault tolerance, byzantine fault tolerance, asynchronous byzantine fault tolerance) or rational behaviour models (e.g. selection models derived from Game Theory that encourage the TCs to maximize some utility function). For example, the selection may be based on game theory, whereby the global committee module selects TC nodes based on parameters that enable Rational Behaviours. Rational Behaviour describes behaviour and set of actions taken by a TC node to promote its own interest most efficiently, whether fair or malicious according to the game theory principles. The analysis and modelling of rational behaviour in networked systems like DLTs may be performed using Game theory techniques, which may be implemented in the form of software package libraries. In general, rational behaviour, according to game theory principles, implies that every actor, in this case the TC node, of a system is motivated to maximise his own payoff. In a stricter sense, it implies that every player always maximizes his utility, thus being able to perfectly calculate the probabilistic result of every action.

According to embodiments of the present invention, the global committee module may select TC nodes based on fault tolerance theories, for example whereby TC nodes are selected based on strategies that satisfy Byzantine Fault Tolerance (BFT). As known in the art, Byzantine behaviour describes the behaviour and consequent set of actions of a node in a DLT that is malicious against the protocol. A node showing byzantine behaviour can act maliciously to perform invalid operations or behave inconsistently. Therefore, Byzantine Fault Tolerance (BFT): is a property of the global consensus module that requires that even in the presence of nodes showing byzantine behaviour, a distributed system will continue to operate correctly according to the protocol.

According to embodiments of the present invention, the global consensus module is configured to submit each transaction for validation to the global committee selection module to reach a validated state for accepting or rejecting the transaction, which validated state is recorded in a global distributed ledger platform. According to embodiments of the present invention, wherein the global consensus module is configured to link local state changes of each connected DLT platform to the global state changes of the global distributed ledger platform. The global consensus module is configured, via the global committee selection module, to push local state changes in the DLT platforms monitored by the selected TC nodes to global state changes in global distributed ledger platform of the Global Consensus module. As such, the global state of the Global Consensus module maintains either all local states (i.e. for DLTs that delegate local consensus to global consensus module) or connections to the local states (i.e. for DLTs that perform local state change and register them to global consensus module) of the distributed ledger platforms. Therefore, the global state of the global consensus module is updated with the submission of new local states. In this way, it is possible to prevent malicious attempts to double-spend previously consumed states of a DLT platform.

According to a third aspect of the present invention, an atomic swap method may be provided for performing an atomic swap transaction for the exchange of digital records between at least one initiator party and at least one collaborator party, the digital records involved in the atomic swap transaction being stored in corresponding DLT platforms associated with the at least one initiator party and at least one collaborator party, the atomic swap method comprising system:

communicatively coupling by means of at least one DLT communication module according to the first aspect of the present invention, each DLT platform participating in the atomic swap engine to a global consensus module;
processing and executing atomic swap transaction requests received from at least one initiator party via a client application involving the exchange of digital records stored in at least one initiator party DLT platform and digital records stored in at least one collaborator party DLT platform; and
validating at the global consensus module the atomic swap transactions;
wherein processing and executing an atomic swap transaction comprises:
locating and validating the digital records referenced in the atomic swap request in the corresponding initiator party DLT platform and collaborator party DLT platform;
executing the atomic swap transaction by assigning the digital records in the initiator DLT platform to the at least one collaborating party and the digital records in the collaborating DLT platform to the at last one initiator party, and locking the exchanged digital records in the corresponding initiator and collaborator DLT platforms,
requesting the at least one initiator party DLT platform to push, via the corresponding DLT communication module, the DLT local state change introduced by the execution of the atomic swap transaction to the global consensus module; and
transferring to the at least one initiator party and at least one collaborator party a key to release the exchanged digital records in the corresponding DLT platforms.

### BRIEF DESCRIPTION OF THE DRAWINGS

The following drawings are provided as an example to explain further and describe various aspects of the invention.

FIGS. 1 and 2 show exemplified embodiments of an atomic swap engine according to the present invention.

FIG. 3 shows an exemplified embodiment of a Global consensus module according to embodiments of the present invention.

FIG. 4 show an exemplified embodiment of a DLT communication module according to embodiments of the present invention.

FIG. 5 shows an exemplified method for integrating private DLT platform to a global consensus module for transaction ordering and timestamping according to embodiments of the present invention.

FIG. 6 shows an exemplified “submit” method for submitting transactions for validation based on the approval of the TC nodes in the corresponding initiator and collaborating DLT platform participating in the atomic swap transaction according to embodiments of the present invention.

FIG. 7 shows an exemplified “ValidateAndLock” method executed by the TC nodes of a participating DLT platform in the swap transaction for validating submitted transactions according to embodiments of the present invention,

FIG. 8 shows an exemplified “swap” method for swapping digital records referenced in an atomic swap transaction according to embodiments of the present invention.

FIG. 9 shows an exemplified “LockToParty” method for locking digital records referenced in an atomic swap transaction to the corresponding parties participating in the atomic swap transaction according to embodiments of the present invention.

FIG. 10 shows an example of an atomic swap transaction between multiple parties according to embodiments of the present invention.

### DETAILED DESCRIPTION

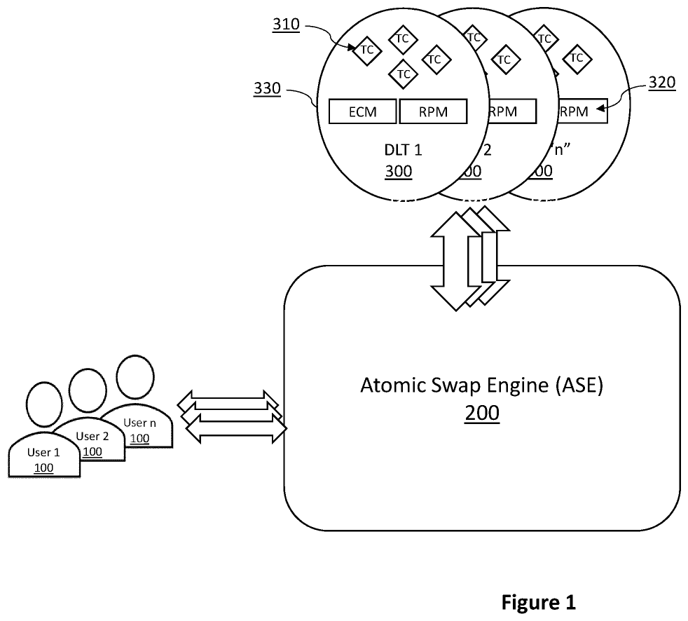

The present invention will be illustrated using the exemplified embodiments shown in the FIGS. 1 to 10, which will be described in more detail below. While this invention has been shown and described with reference to certain illustrated embodiments thereof, it will be understood by those skilled in the art that various changes in form and details may be made therein without departing from the scope of the invention encompassed by the appended claims. Furthermore, while the invention has been described with references to a particular system and/or a method for performing atomic swap transactions it should be understood by those skilled in the art that changes in form and details may be made to facilitate other types of method and/or systems in related fields without departing from the scope of the invention encompassed by the appended claims. For example, although the invention has been described with references to DLT platforms, it would be appreciated that atomic swap engines may be initiated between other types of systems that have the capability of storing digital records and maintaining the state of the system, such as distributed databases.

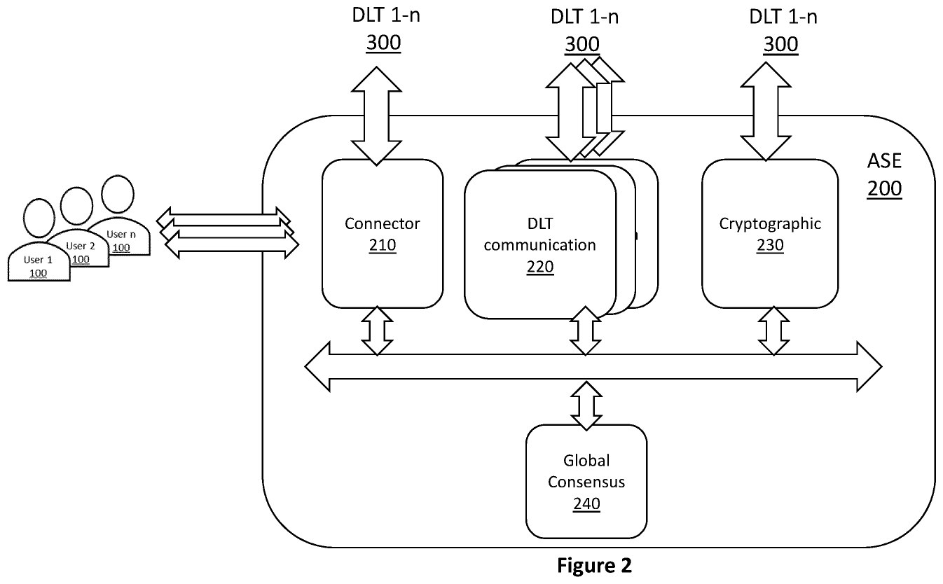

FIGS. 1 and 2 show exemplified embodiments of an atomic swap engine (ASE) 200 according to the present invention. The ASE 200 may be provided in the form of a platform, which is configured to safely perform distributed ledger digital record, also referred to as digital asset, exchange transactions among several parties (User 1-n) 100 in several distributed ledger platforms (DLT1-n) 300. The exchange transactions are commonly referred as atomic swaps. Users (user 1-n) 100 willing to initiate an atomic swap transaction connect via a client application software running on their electronic devices to the ASE 200 platform to initiate an atomic swap transaction. A user initiating an atomic swap transaction may be referred to as an initiator party. The initiator party specify the digital records to be exchanged, the DLT platform or platforms (DLT 1-n) 300 storing the digital records and indicate at least one collaborating party. The ASE 200 platform processes the atomic swap transaction requests and communicates with the corresponding DLT platforms 300 of the initiator and collaborating party/parties storing the referenced digital records to obtain local DLT state information from a local consensus protocol to validate the presence of the digital records. A Consensus Protocol may be considered to be any kind of distributed system that seeks to achieve cooperation among the set of processes it executes. In this way a consensus protocol may be used by transaction processing nodes 310 to keep the transaction processing and history consistent in the DLT platform. It may be assumed that DLT platforms 300 employ consensus protocols in a private/permissioned setting, with known and invite only participants. Nodes or parties take part in the consensus protocol by voting, putting stakes or other consensus algorithm parameters. The consensus power of a node 310 may be measured as the ratio of its consensus parameter values over the sum of all the nodes' 310 consensus parameters values participating in the consensus protocol.

As shown in FIG. 1, each DLT platform 300 may be provided with a consensus protocol comprising a set of Transaction Checker (TC) nodes 310. Each Transaction Checker (TC) node 310 may be a computing node taking part in a consensus protocol of a DLT platform configured to validate submitted transactions and performing state changes in the DLT platform 300. In general, the state of a DLT platform represents an evolving sequence of transactions in discrete time slots, that are processed and validated through the consensus protocol of the DLT. There are different models to represent the state of a DLT, with the UTXO model and the account model as the most common. In some cases, the DLT platform 300 may decide to delegate the consensus process for validating transactions and performing states changes to a global consensus module. Indeed, the ASE platform 200 according to embodiments of the present invention, as it would be describe in more details below, in addition to enabling execution of the atomic swap transactions, may be used by private/permissioned DLT platforms 300 as consensus provider module for both local and atomic swaps transactions without leaking any confidential information. Moreover, the ASE platform 200 may ensure transaction finality without causing leakage of confidential information. In general, in order to perform atomic swap transactions, ASE platform 200 may divide parties involved in the atomic swaps into two groups name as initiators and collaborators. Let's consider the following scenario for an atomic swap transaction that consists of multiple parties:
AssetX belongs to Alice in DL1
AssetY belongs to Bob in DL2
AssetZ belongs to Carol in DL3
AssetQ belongs to Dave in DL4
Let's assume we have an atomic swap transaction represented as:

AssetX, AssetY-->AssetZ, AssetQ, which reads as: swap AssetX in exchange of AssetZ and AssetY in exchange of AssetQ. In this transaction, Alice and Bob are initiators, and, Carol and David are collaborators. Initiator parties Alice and Bob initiates the atomic swap operation with collaborator parties Carol and Dave through the Connector Module. As shown in FIG. 1, the each DLT platform 300 connected to the ASE platform 200 may comprise an Escrow Contract Module (ECM) 330, and a Reward/Penalties Module (RPM) 330.

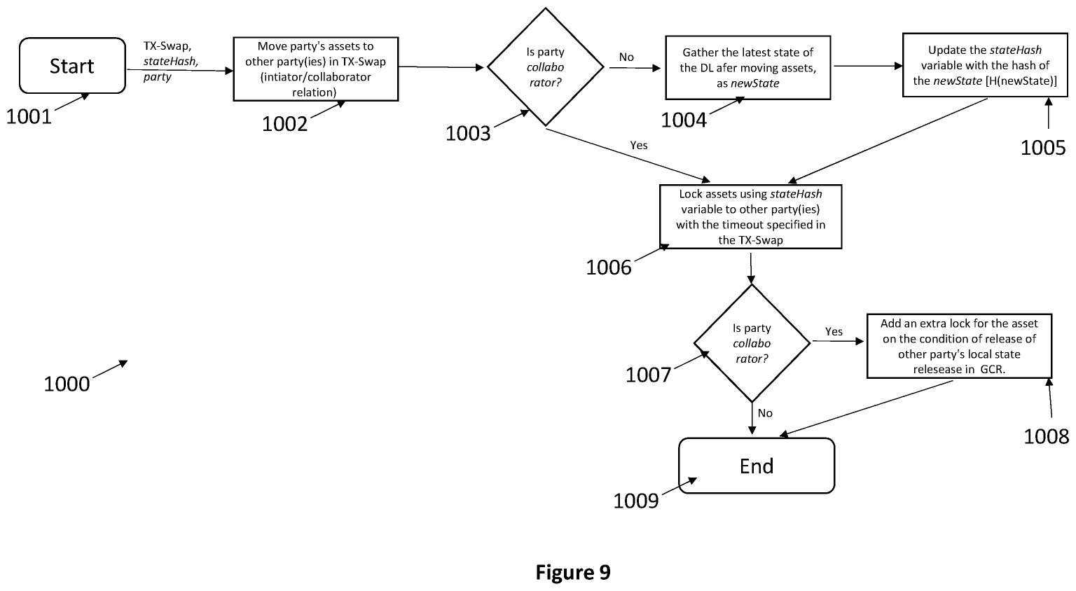

The ECM module 330 may be configured to perform asset locking operations in order to assist execution of the atomic swap transactions. The ECM module 330 may comprise a multiple signature Hashed Time Lock Contract (HTLC) that perform locking operations. The HTLC may be a type of a smart contract that is executed in each participating DLT to lock the digital records/assets referenced in the atomic swap transaction. In general, but not exclusively, the ECM module 330 is configured to perform at least the following operations:
Locking asset to an escrow account, whereby the ownership of a digital record/assets referenced in the atomic swap transaction is locked to an escrow account in the DL, thus preventing prevent any changes to be made on the referenced digital record/asset's ownership until the completion of the atomic swap operation. The locking operation may include a timeout period, such that if the atomic swap operation takes longer than a specified timeout period, then the ECM module 330 may be configured to unlock the referenced digital records/asset.
Locking asset to another party: the ECM module 330 is configured to lock assets to another party with pre-defined conditions using a LocktoParty method, which would be explained below with reference to FIG. 9. For example, the locking of digital assets may be performed by means of a secret key and timeout using hash lock and time locks.

The Reward/Penalties Module (RPM) may comprise a set of algorithm libraries for instantiating rewards and penalties to TCs nodes 310 when a malicious or honest behaviour is detected by the global consensus module of the ASE.

FIG. 2 shows an exemplified embodiment of the ASE platform 200 architecture according to embodiments of the present invention. As shown, the ASE platform 200 may be provided with a connector module (CM) 210, at least one DLT communication module 220, a cryptographic module 230, and a Global Consensus module 240. Each of the ASE platform 200 modules is communicatively coupled to one another for the exchange of information. The connector module (CM) 210 is configured to execute atomic swap transactions by acting as a central orchestrating hub. The CM 210 is configured to receive atomic swap transaction requests from the initiator parties, communicate with each participating DLT platform 300 to validate the referenced digital records/assets, communicate with the collaborating party/parties to obtain confirmation that the atomic swap transaction is accepted, and execute the atomic swap transaction. For example, the CM 210 upon receiving via a client application software a notification from the at least one collaborating party that the atomic swap transaction is accepted, is configured to:
locate and validate the digital records referenced in the atomic swap request in the corresponding initiator party DLT platform 300 and collaborator party DLT platform 300,
execute the atomic swap transaction by assigning the digital records in the initiator DLT platform 300 to the at least one collaborating party and the digital records in the collaborating DLT platform 300 to the at last one initiator party, and locking the exchanged digital records in the corresponding initiator and collaborator DLT platforms 300,
request the at least one initiator party DLT platform 300 to push, via the corresponding DLT communication module 220, the DLT local state change introduced by the execution of the atomic swap transaction to the global consensus module 240; and
upon receiving a confirmation from the corresponding DLT communication module that the atomic swap transaction is validly processed by the global consensus module, to transfer to the at least one initiator party and at least one collaborator party a key to release the exchanged digital records in the corresponding DLT platforms.

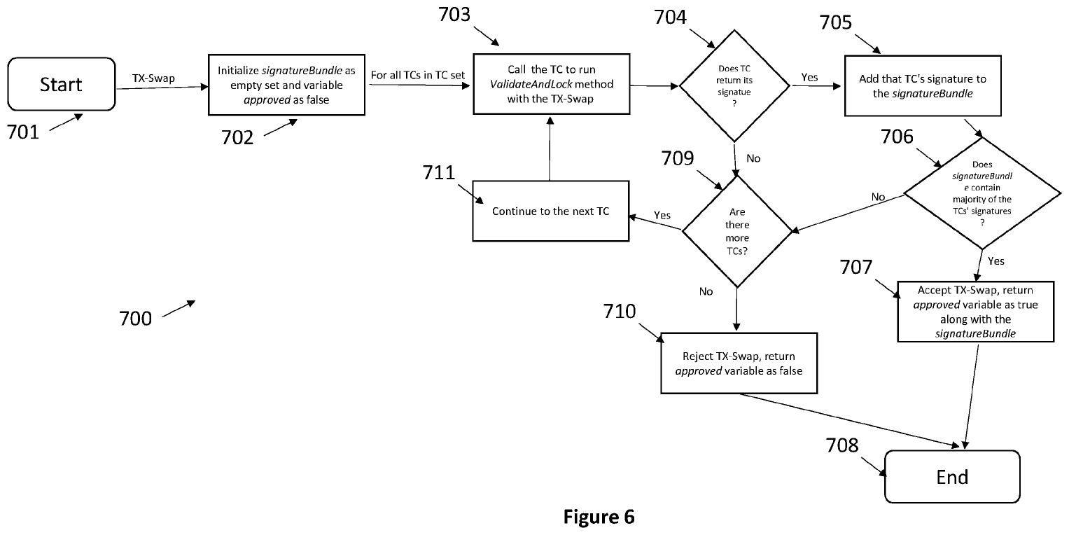

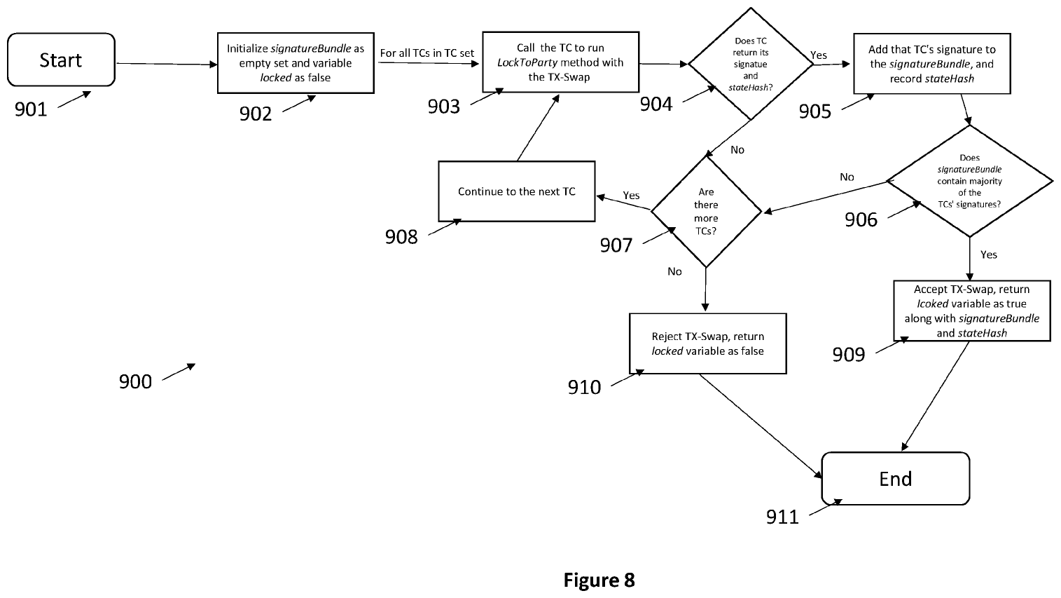

An example of how the CM 210 executes an atomic swap transaction is provided here with references to FIGS. 6 to 9:
Initiator parties starts the atomic swap transaction in CM 210 through their Client Software.
CM 210, for assets of the all initiator parties, runs the Submit method, shown in FIG. 6, in initiator parties' DLT platform 300. Where, if the transaction is valid and approved by TCs nodes 310 (i.e. assets of initiator parties exist and belongs to them), ownership of initiator parties' assets transferred to escrow in their local DL through ECM.
CM 210 then transfers atomic swap requests to all collaborator parties. If they agree to perform the atomic swap, CM 10 runs the Submit method, described in FIG. 6, to lock the assets of collaborator parties in their DLs.
CM 210 notifies all initiator parties and, triggers execution of Swap method, described in FIG. 8, for referenced digital records/assets of the initiator parties. The ownership of assets is moved and locked to respective new parties with the ECM's LockToParty method, described in FIG. 9, which uses representation of the local state change as secret input while locking asset to respective collaborator party.
CM 210 transfers output stateHash of the LockToParty method's locking operation, to respective collaborator parties.
CM triggers execution of the swap method for each collaborating party, where the stateHash transferred by the CM 210 from their respective initiator party DLT platform 300 is used in the LockToParty method to lock the asset with the timeout and additional condition of assertion of submission and process of initiator party's newState in the Global consensus module 240.
CM keeps track of the execution of the swap method for all collaborator parties.
When all collaborator parties' assets are locked with the Algorithm Swap, CM triggers TCs 310 in the DLT platform 300 of initiators parties to share newState with Global consensus module 240 through the corresponding DLT communication module 220.
CM 210 triggers initiator parties unlock their new assets by releasing newState value and reference to the Global consensus state that consists of newState, and following that, collaborator parties unlocks their assets using the newState value to unlock their new assets.

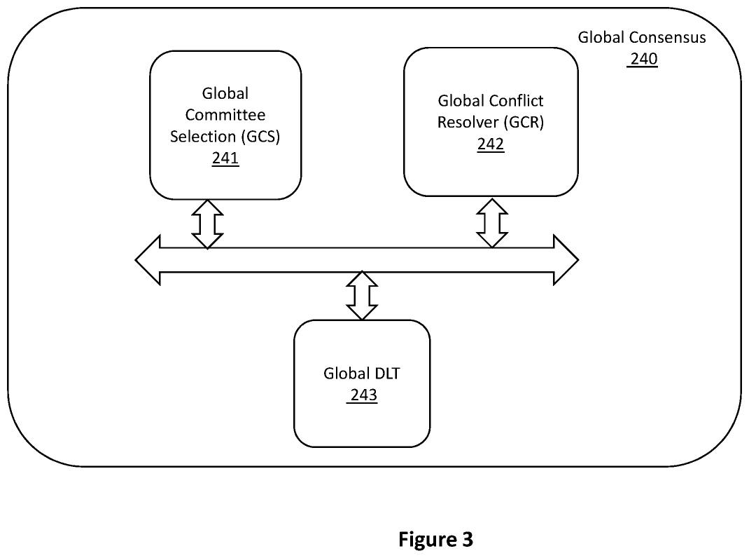

FIG. 3 shows an example of a Global consensus module 240 according to embodiments of the present invention. The Global consensus module 240 is configured to validate, record and track local DLT state changes in all DLT platforms 300 connected to the ASE platform 200. The global consensus module 240 may be provided with a Global Committee Selection module (GCS) 241, a Global Conflict Resolver (GCR) module 242, and a global DLT 243. The GCS module 241 connects to the GCR module 242 and selects local TC nodes 310 from all of the connected DLT platforms 300 to form a global set of TC nodes 310 that participates in the GCR consensus protocol. The GCR module 242 is configured for validated submitted transaction by applying a consensus protocol based on the selected global set of TC nodes. The GCR 242 may consist of a consensus module which is configured to apply a consensus protocol that satisfies safety and liveliness requirements and provides ordering and global consensus on the local DLT state changes. The global state of the GCR is tracked using a global DLT 243. The global GCR's state changes through the submission of local DLT states from the connected DLT platforms 300 it through the GCS module 241. As a result, a state change in a DLT platform 300 would result in a change in the global DLT state of the GCR 242. If a DLT platform 300 delegates the reaching of local consensus to the global consensus module 240, then every transaction is submitted to GCR through the DLT communication module 220. The information relating to the transaction is kept confidential by means of the cryptogram module. On the other hand, if a DLT platform 300 reaches consensus locally, with its own consensus protocol, the DLT platform 300 submits its local state changes to the Global consensus module 240 through the DLT communication module. In general, the main task of the Global consensus module 240 is to gather and persist state changes of all DLT platforms 300 connected to the ASE platform 200 through the global set of TC nodes 310 that apply the consensus protocol. The global consensus module 240, by means of the GCR 242, provides state validation and global consensus order for all DLT platforms 300, through an embedded consensus module. Once GCR 243 reaches a consensus on a state submitted by a DLT platform, this state is now considered as global, and after that point DLT platforms can't collude by forking and changing their local DLT state and claiming that the global state that is shared with the GCR 243 is invalid.

The Cryptographic Toolbox (CT) 230 may be configured to secure information exchanged between the modules of the ASE platform 200. The CT 230 may consist of a set of cryptographic algorithms and libraries, which are used to perform a range of operations, such as Data Obfuscation, Data Encryption, Data Pseudonymization and Anonymization, and Data hashing.

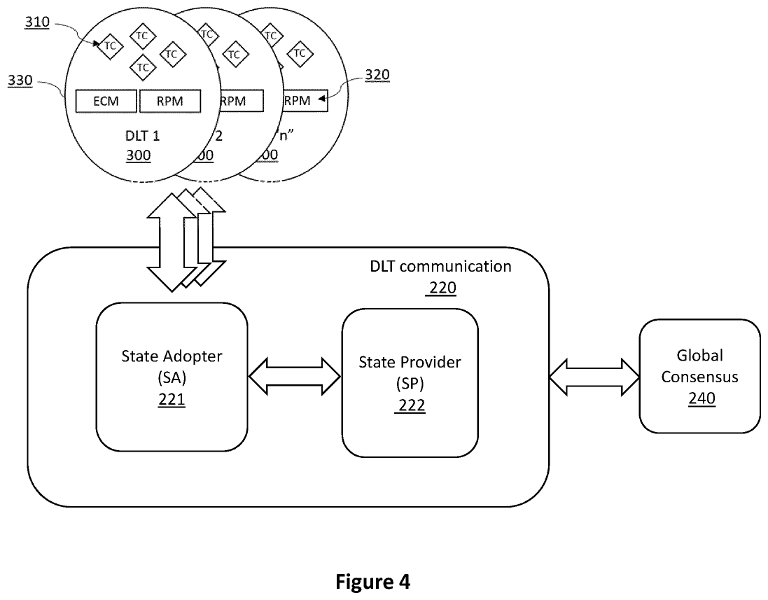

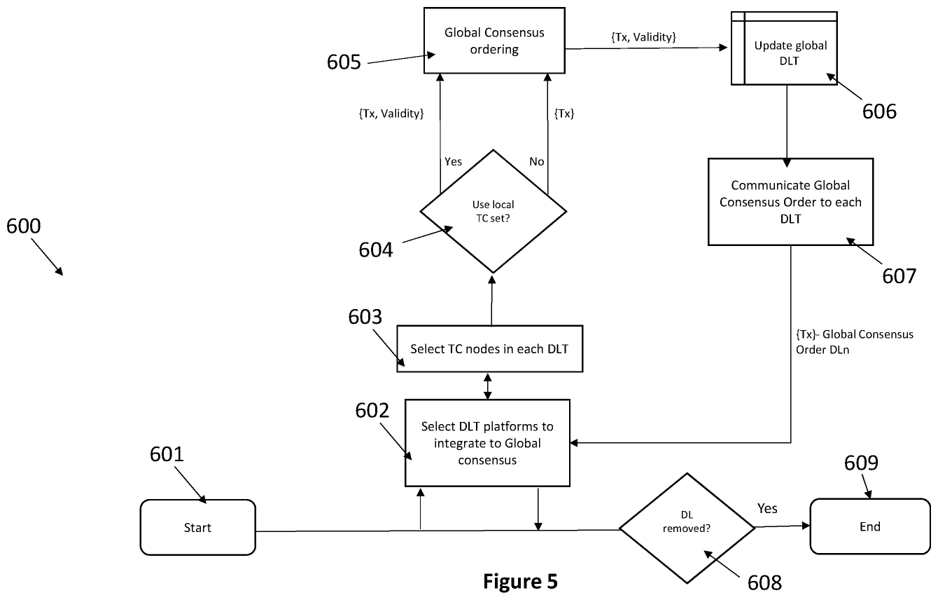

FIGS. 4 and 5 show examples of DLT communication module 220 and a method for connecting a DLT platform 300 to the ASE platform 200 according to embodiments of the present invention. The DLT communication module 220 is configured to connect heterogeneous DLT platforms 300 to the ASE platform 200 to perform state transfers between the DLT platform 300 and the Global consensus module 240. The DLT module 220 is configured to push local DLT states of a DLT platform 300 to the Global consensus module 240, irrespective of the technology or configuration of the DLT platform 300. The DLT communication module comprises a state adopter (SA) module 221, which is configured to push local DLT state changes to the GCR 242. The SA 221 comprises a communication module provided with a communication protocol library storing a plurality of communication protocols and associated DLT configurations. Each communication protocol is designed to retrieve and push local DLT state changes to GCR 242, thus enabling for DLT platforms 300 having different configurations to connect to the ASE platform 200. In the case where the DLT platform 200 connected to the SA 221 delegates the reaching of local consensus to GCR 242, then SA 221 fetches every new transaction from the global set of TC nodes that are selected by the GCS 241 and submits every transaction to the GCR 242. Upon completion of transaction's processing in the GCR 242, if the transaction is valid and accepted by GCR 242, SA 221 returns the consensus order and timestamp of the transaction to the local TC set of the connected DLT platform 300. If the transaction is rejected, then it notifies the local TC nodes 310 that the transaction is not valid. In the case where, the DLT platform 300 connected to the SA 221 reaches consensus locally with its own consensus protocol, then SA 221 fetches local state changes from the TC nodes in the global set of TC nodes associated with the connected DLT platform 300 that are selected by the GCS 241 and submits only the state changes to the GCR 242. Upon completion of processing the submitted states the GCR 242, SA 221 returns the consensus order and the timestamp of the processed state to the local TC nodes 310 of the DL. The DLT communication module may be provided with a state provider (SP) module 222, which is connected to the SA module 221 and GCR 242. In general, the SP 222 is configured to follow and monitor the latest status of state changes in the global GCR state stored in the global DLT 243 and pushing those changes to the SA 221. The SP 222 enables local TC nodes 310 in the connected DLT platforms to:
gather global consensus order and timestamp of the submitted transaction/state of the DL,
to provide confirmation that a DLT platform local state has been processed globally, for example in the case of an atomic swap transaction.

FIG. 5 shows a method 600 for connected a DLT platform 300 to the Global consensus module 240 of the ASE platform 200 by mean of the DLT communication module. The process starts at step 601, where an action is initiated e.g. via a client application, to connect a DLT platform 300 to the ASE platform 200. The DLT platforms 300 to be integrated are selected at step 602 and a connection is established via the DLT communication module 220 to the global consensus module 240. At step 603, the GCS 241 selects the TC nodes to form the global set of TC nodes, and determines whether the connected DLT platform 300 delegates the consensus to the GCR 242 or it reaches consensus locally and accordingly decides at step 604 whether to use the local set of TC nodes, in the presence of a local consensus protocol, or not, in the case of consensus delegation. If the local TC nodes 310 are used, then the transaction information and the validity information from each participating TC node is transferred to GCR for global consensus ordering at step 604, otherwise only the transaction information may be transferred. The transaction information may comprise information on the atomic swap transaction, and/or the DLT state, and/or the local DLT state changes. At step 604 global consensus ordering is checked and validated, and the global DLT is updated with the new state at step 606. The new global state of the GCR is communicated to the connected DLT platforms at step 607. Once the DLT platforms 300 are removed at step 608, then the process of integrating local DLT states ends at step 609.

It should be noted that although the DLT communication module 220 is presented herein as part of the ASE platform 200, it can be equally used as a stand-alone component to integrate private/permission DLT platforms, or other distributed databases to any global consensus module e.g. Hedera. An example of an execution flow is presented below for the integration of local states for a corda-HCS using a DLT communication module according to the present invention.

### Execution Workflow:

1. A transaction is submitted to the private Corda blockchain instance through a client application.
2. Corda invokes the selected notary(ies) (TC nodes 310) with the transaction to sign. Transaction contains all the states (I.e. objects that represent status of the ledger as shared facts) that are either used or merely referenced by that transaction.
3. SA module 221 fetches the transaction, and all submitted states from notary(ies).
4. SA module 221, by using Cryptographic Toolbox (CT) 230 anonymizes the transaction and its states.
5. SA module 221 submits the anonymized transaction and states to the HCS for global consensus.
6. HCS, by using the public Hedera network, gets a consensus order and the global timestamp for the transaction.
7. SA 221, by using an SP 222 component e.g. Kabuto, searches all transactions processed by the HCS that are consuming any of the same states used/referenced by the submitted transaction.
8. SA 221 compares the unique consensus orders and timestamps of the transactions that use/reference the states of the transaction.
9. SA 221, through notary service of the Corda, verifies whether the transactions that needs to be verified and signed by the notary was the first to attempt to spend all its states, and that its reference states have not yet been spent.

a. If this transaction is the first, then SA 221 notifies the Corda notary and notary signs the transactions. Now, the transactions are valid in the local private Corda blockchain.

b. If this transaction is not the first one that tried to use/reference the states, then SA 221 notifies the notary to reject the transactions. Then, client application that submitted the transaction gets notified by the Corda that the transactions is not notarized so it is not valid.

FIG. 6 shows an example of a “submit” method 700 as previously discussed. The submit method starts at step 700, when a swap transaction is initiated. At step 702, the signatureBundle are initialised as empty set and variable approved as false. For all TCs 310 in the TC set, call the TC to run ValidateAndLock method with the TX-Swap at step 703. If the TC returns a signature at step 704, then add the TC signature to the signaturebundle at step 705. Otherwise check at step 709 if there are more TCs and if yes continue at step 711 to the next TC and move back to step 703. In the case, where there are no more TCs then the swap transaction is rejected at step 710 and the process ends at step 708. Once the transactions are added to the signaturebundle at step 705, then the signaturebundle is checked at step 706 to determine if it contains all TCs. If it does, then the process ends at step 708, otherwise it is moved to step 709, when it is checked if there are any more TC.

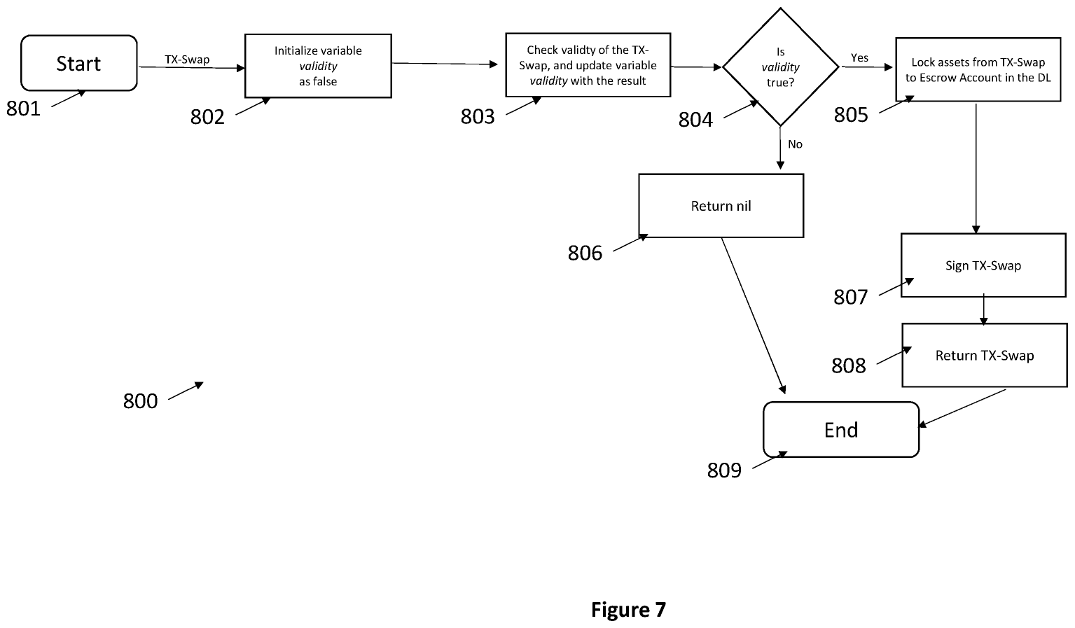

FIG. 7 shows an example of a validation method 800 for validating atomic swap transactions. At step 800 the validation method is initiated, and the variable validity is initialised to false at step 802. The validity of the atomic swap transaction is checked at step 803, and if the validity is confirmed at step 804, then assets are locked to escrow account at step 805. Subsequently, the transaction is signed at step 807 and the transaction is returned at step 808, at which point the process ends at step 809. In the case where at step 804, the validity is not confirmed, the nil is returned at step 806 and the process ends.

FIG. 8 shows an example of a swap method according to embodiments of the present invention. The process starts at step 901, and the “signaturebundle” is initialised as empty and the “locked” variable is set at false at step 902. At step 903, all TCs in the TC set run the LoctoParty method of FIG. 9 with the transaction swap. If the TCs return the signature and stateHash, at step 904, then the TC signature is added to the signaturebundle. Otherwise, at step 907 it is checked if there are more TC, and the process moves to step 908 for processing the next TC. At step 906, it is checked whether the signaturebundle contains the majority of TCs, if yes, the transaction is accepted at step 909 and the process ends at step 911. In the case where at step 907 it is determined that there are no more TCs, the swap transaction is rejected and step 910 and the process ends at step 911.

FIG. 9 shows an example of a LocktoParty method. In the LockToParty method, the ownership of an asset transferred to the respective collaborator party causes a state change in the initiator parties' DL, which it is assumed to be represented as newState. For the initiator parties, newState is used as secret input of a cryptographic hash function to lock the asset to collaborator party, as H(newState) with output stateHash, with a timeout period. I.e., in order to unlock the asset, the collaborator party has to provide this newState value before timeout. On the other hand, to lock the asset of the collaborator parties, the LockToParty method behaves differently:
It uses stateHash value transferred by CM 210
It adds additional condition on locking, which requires to verify the secret input newState of the initiator party, submitted to and processed by the GCR 242 through the GCS module 241. In general, the LocktoParty method treats the initiator party and collaborator party differently, such that if the party involved in the operation of this method is collaborator party, which is checked in step 1002 and 1007, it performs some extra steps in the atomic swap operations.
   The way how LockToParty method performs locking of assets and the requirement to share the local state with the GCR allows execution of multiple party atomic swaps. Specifically, with this way, atomic swaps containing multiple assets among multiple parties are performed by using different secret inputs (I.e. local states). This allows to:

Parallelize the execution of atomic swap operations with multiple assets and parties, such that while one initiator party is interacting with its respective collaborator party, another initiator party can interact with its respective collaborator party. This is also a very nice technical feature that directly affects the performance and scalability of the protocol. To be decided if we want to stress it a lot in patent, comparative analysis document and any other technical document that will be the outcome of this.

guarantee correctness of the atomic swap, once the local state is shared with the GCR it can't be reverted. And if it is never shared with the GCR, atomic swap transaction is never executed.

According to embodiments of the present invention and exemplified scenario of a 1-to-1 atomic swap transaction is presented below. It should be noted that the example below may be also applied to multi-party atomic swap transactions.

### Example of 1-1 Atomic Swap Transaction

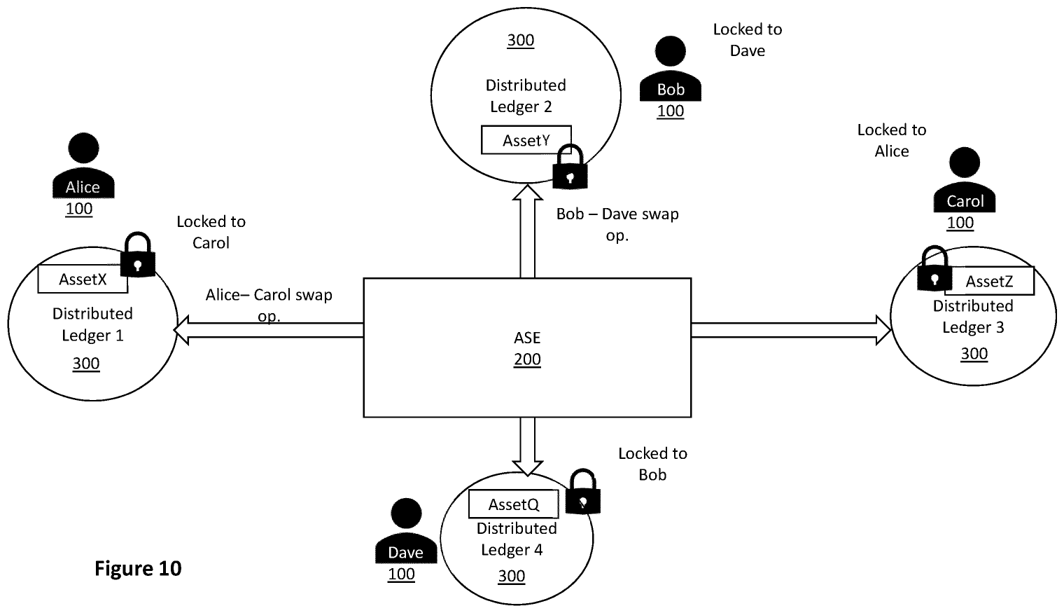

As a perquisite, the Connector Module 210 is configured to punishes any user who tries to collude by aborting the transaction in between any two steps, by cutting some fee from deposited asset.
Step 1: Alice, as an initiator party, initiates a transaction through a client application, i.e. wallet, to swap her asset AssetA in DL1 with Bob's asset AssetB in DL2, by attaching her signature and defining a timeout period, such as: TX-Swap(AssetA of Alice in DL1, AssetB of Bob in DL2, Alice's Signature, Timeout, Bob)
Step 2: Client application submits TX-Swap to CM 210.
Step 3: CM 210 starts running Submit method of FIG. 6 for initiator party Alice.
Step 4: In Submit method, validity of the transaction TX-Swap is assured with the approval of TCs in DL1. Where, TCs execute of ValidateAndLock method (see Method 1), and if the TX-Swap is valid, Alice's asset AssetA is locked to an escrow account.
Step 5: Connector Module collects all the signatures from TCs into a signature bundle.
a) If majority of the TCs approve by sending their signatures (we use “majority” as lower bound threshold for consensus, it's certain value depends on the consensus algorithm used by DL, as such, for BFT algorithms it will be two thirds of the total votes plus one), then transaction is considered valid.
b) If less than majority of TCs approve, transaction will be rejected, and user will be notified.
Step 6: Upon collecting majority of the signatures, CM sends the atomic swap transaction to the Bob through his client application.
Step 7: Bob's client application responds to Connector Module with his signature if it agrees to perform the atomic swap for his asset AssetB. If Bob rejects the atomic swap, Connector Module triggers the unlock of Alice's asset AssetA in DL1 and notifies the Alice that transaction is rejected.
Step 8: If Bob agrees to trade, Connector Module repeats the operations performed in Step 3 and Step 4 for Bob in DL2 to lock Bob's asset AssetB in DL2 to an escrow account.
Step 9: CM collects all signatures from TCs in DL2.
a) If majority of the TCs in DL2 approve, CM continue with the Step 10.
b) If less than majority of TCs approve, atomic swap transaction will be rejected, and CM will trigger the unlocking of Alice's asset AssetA in DL1.
Step 10: Upon confirmation, Connector Module 210 runs Swap method of FIG. 8 for the initiator party Alice.
Step 11: CM triggers all TCs in DL1 to execute LockToParty method of FIG. 9 for TX-Swap atomic swap transaction as an initiator party. TCs execute the LockToParty method and return their signature and stateHash value.
Step 12: CM collects all signatures from TCs in DL1.
a) If majority of the TCs in DL1 approve, CM continues with the Step 13.
b) If less than majority of TCs approve, atomic swap transaction will be rejected, and CM will trigger the unlocking of Alice's asset AssetA in DL1 and Bob's asset AssetB in DL2.
Step 13: Connector Module 210 notifies Bob's client application that Asset A is now locked to Bob with the stateHash value.
Step 14: CM 210 triggers all TCs in DL2 to execute LockToParty method for TX-Swap atomic swap transaction as an initiator party by supplying the stateHash value. TCs execute the LockToParty method and return their signature.
Step 15: CM triggers TCs in the DL1 to share newState with GCR module through GCS module.
Step 16: SA module 221, that is connected to the DL2 and Bob's client application, monitors the GCR to track whether DL1 has shared the newState with the GCR module. SA module notifies the TCs in the DL2 and Bob's client application when it confirms that newState has been processed by the GCR 242.
Step 17: Alice unlocks her new asset AssetB in DL2 by using newState value and reference to GCR state that contains newState.
Step 18: Bob unlocks his new asset AssetA in DL1 by using the newState value.
   Following the previous example of an 1-1 atomic swap transaction, FIG. 10 shows an example of an atomic swap transaction TXSwap between multiple parties 100 in different distributed ledger technology platforms 300 according to embodiments of the present invention. The example shown follows the one presented earlier with reference to FIG. 1. TXSwap is represented as TXSwap (AssetX, AssetY-->AssetZ, AssetQ) which reads as: swap AssetX in exchange of AssetZ and AssetY in exchange of AssetQ, where:
AssetX belongs to Alice in DL1
AssetY belongs to Bob in DL2
AssetZ belongs to Carol in DL3
AssetQ belongs to Dave in DL4

FIG. 10 illustrate that swap operations that are part of the TXSwap, i.e. swap of assets between Bob, Dave, Alice, and Carol are performed in parallel. FIG. 10 illustrate that invention protects the atomicity of the TXSwap performing asset swaps only after all parties involved have agreed and performed their tasks accordingly as defined by the protocol. Such that, in order for assets to swap between parties, all operations must finish successfully, otherwise TX-Swap is aborted and this protects atomicity. This means even that Bob and Dave, even if two of them agree, can only exchange their assets if Alice and Carol agree and performs required steps as specified by the ASE protocol. The transactions can be performed in parallel due to the LocktoParty method, whereby the assets of each party are locked in the escrow module before they are swaps, thereby ensuring the atomicity of the transaction i.e. the transaction would only be executed if all parties 100 agree.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. The computer readable program instructions for carrying out operations of the embodiments of the invention may be, for example, assembly language or either source code or object code is written in any combination of one or more programming languages.

The program code embodied in any of the applications/modules described herein is capable of being individually or collectively distributed as a program product in a variety of different forms. In particular, the program code may be distributed using the computer readable storage medium having the computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other robust state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general-purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more, or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention of the Applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicants general inventive concept.

1. A distributed ledger, DLT, communication module configured for connecting a distributed ledger technology, DLT, platform with a global consensus module for consensus ordering and timestamping, wherein the DLT communication module comprising:
a state adopter module configured to retrieve and push to the global consensus module transactions submitted to the DLT platform, the transactions at least referencing local states and/or local state changes of the DLT platform; and a status provider module configured to maintain and track the transactions processed by the global consensus module;
wherein the state adopter module is configured to search in the status provider module for processed transactions containing any of the local states and/or local state changes referenced in the submitted transactions, and upon finding matching transactions notifying the at least one DLT platform of the valid processing of the submitted transactions by the global consensus module.

2. A DLT communication module according to claim 1, wherein the state adopter module comprises a local state communication module configured to retrieve transactions submitted to the DLT platform.

3. A DLT communication module according to claim 2, wherein the local communication module comprises a communication protocol library comprising a plurality of communication protocols, each associated with a DLT platform configuration.

4. A DLT communication module according to claim 3, wherein the local communication module is configured to identify the communication configuration of the connected DLT platform and accordingly select a compatible communication protocol from the communication protocol library to enable the exchange of information.

5. A DLT communication module according to claim 4, wherein the local communication module is configured to convert the format of information exchanged between the connected DLT platform and the global consensus module.

6. A DLT communication module according to claim 1, wherein the state adopter module comprises a DLT state checking module configured to search in the status provider module for historical transactions consuming any of the DLT local states associated with the submitted transaction, and to compare the unique consensus orders and timestamps of the any historical transaction identified as consuming any of the DLT local states to detect previous attempts for consuming the DLT local states associated with the submitted transaction.

7. A DLT communication module according to claim 6, wherein the DLT state checking module is configured for retrieving information on consumed DLT local states from a local DLT consensus module.

8. A DLT communication module according to claim 6, wherein the DLT state checking module is configured upon detecting that the local states associated with the submitted transaction have been consumed by a previous transaction, the state adopter module is configured to notify the distributed ledger platform to reject the submitted transaction, otherwise the state adopter module is configured to notify the DLT platform to validate the submitted transaction.

9. A DLT communication module according to claim 1, wherein the status provider module is a mirroring computing node configured to push global DLT state changes of the global consensus module to the state adopter module.

10. An atomic swap engine for orchestrating the exchange of digital records involved in an atomic swap transaction between at least one initiator party and at least one collaborator party, the digital records involved in the atomic swap transaction being stored in corresponding DLT platforms associated with the at least one initiator party and at least one collaborator party, the atomic swap system comprising:
a connector module configured to process and execute atomic swap transaction requests received from at least one initiator party via a client application involving the exchange of digital records stored in at least one initiator party DLT platform and digital records stored in at least one collaborator party DLT platform;
a global consensus module configured to validate, record and track state changes of the connected DLT platforms participating in the atomic swap transactions; and
at least one DLT communication modules according to claim 1, configured to communicatively couple each DLT platform to the global consensus module;
wherein upon receiving via a client application software a notification from the at least one collaborating party that the atomic swap transaction is accepted, the connector module is configured to
locate and validate the digital records referenced in the atomic swap request in the corresponding initiator party DLT platform and collaborator party DLT platform,
execute the atomic swap transaction by assigning the digital records in the initiator DLT platform to the at least one collaborating party and the digital records in the collaborating DLT platform to the at last one initiator party, and locking the exchanged digital records in the corresponding initiator and collaborator DLT platforms,
request the at least one initiator party DLT platform to push, via the corresponding DLT communication module, the DLT local state change introduced by the execution of the atomic swap transaction to the global consensus module, and
upon receiving a confirmation from the corresponding DLT communication module that the atomic swap transaction is validly processed by the global consensus module, to transfer to the at least one initiator party and at least one collaborator party a key to release the exchanged digital records in the corresponding DLT platforms.

11. An atomic swap engine according to claim 10, wherein the atomic swap engine comprising a cryptographic module configured to anonymise the retrieved transactions.

12. An atomic swap engine according to claim 11, wherein the cryptographic module is configured to anonymize the retrieved transaction by removing and/or obfuscating sensitive information attributed to a specific data subject.

13. An atomic swap engine according to claim 11, wherein the cryptographic module is configured to hash and/or encrypt the retrieved transactions.

14. An atomic swap engine according to claim 11, wherein the connector module is configured to lock the exchanged digital records using a state hash value key generated by means of the cryptographic module from a hash function obtained from a state change of the at least one initiator DLT platform.

15. An atomic swap engine according to claim 14, wherein the cryptographic module is configured to generate separate state hash value keys for the at least one initiator party and at least one collaborator party to inlock the respective swapped digital records.

16. An atomic swap engine according to claim 15, wherein the initiator party key is generated based on the state hash value and a reference to the state changes of the global consensus module distributed ledger platform.

17. An atomic swap engine according to claim 11, wherein the connector module is communicatively coupled to an escrow module configured to lock the digital records involved in the atomic swap transaction using the generated state has value keys.

18. An atomic swap engine according to claim 17, wherein the escrow module comprises a smart contract programme operating on each connected DLT platform, which is configured to lock the digital records with time-bounds using hash locks and time locks generated from cryptographic hash functions and cryptographic signatures.

19. An atomic swap engine according to claim 17, wherein the escrow module is configured to release the locked digital records upon certain conditions of the atomic swap execution being satisfied.

20. An atomic swap engine according to claim 10, wherein the global consensus module comprises a global committee selection module configured for selecting Transaction checker (TC) nodes from connected DLT platform to form a set of global transaction consensus nodes participating in the validation, recording and tracking of state changes of the connected DLT platforms participating in the atomic swap transactions.

21. An atomic swap engine according to claim 20, wherein the global selection module is configured to select the TC nodes based on a number of parameters that are defined according to and satisfy fault tolerance principles or rational behaviour models.

22. An atomic swap engine according to claim 10, wherein the global consensus module is configured to submit each transaction for validation to the global committee selection module and record each valid transaction in a global distributed ledger platform.

23. An atomic swap engine according to claim 22, wherein the global consensus module is configured to link local state changes of each connected DLT platform to the global state changes of the global distributed ledger platform.

24. An atomic swap method for performing an atomic swap transaction for the exchange of digital records between at least one initiator party and at least one collaborator party, the digital records involved in the atomic swap transaction being stored in corresponding DLT platforms associated with the at least one initiator party and at least one collaborator party, the atomic swap method comprising:
communicatively coupling by means of at least one DLT communication module according to claim 1 each DLT platform participating in the atomic swap engine to a global consensus module;
processing and executing atomic swap transaction requests received from at least one initiator party via a client application involving the exchange of digital records stored in at least one initiator party DLT platform and digital records stored in at least one collaborator party DLT platform; and
validating at the global consensus module the atomic swap transactions; wherein processing and executing an atomic swap transaction comprising:
locating and validating the digital records referenced in the atomic swap request in the corresponding initiator party DLT platform and collaborator party DLT platform;
executing the atomic swap transaction by assigning the digital records in the initiator DLT platform to the at least one collaborating party and the digital records in the collaborating DLT platform to the at last one initiator party, and locking the exchanged digital records in the corresponding initiator and collaborator DLT platforms,
requesting the at least one initiator party DLT platform to push, via the corresponding DLT communication module, the DLT local state change introduced by the execution of the atomic swap transaction to the global consensus module; and
transferring to the at least one initiator party and at least one collaborator party a key to release the exchanged digital records in the corresponding DLT platforms.
